(19) United States
(12) Patent Application Publication
(10) Pub. No.: US 2018/0293234 A1
(43) Pub. Date: Oct. 11, 2018

(54) CURATING OBJECTS

(71) Applicant: BDNA Corporation, Mountain View, CA (US)

(72) Inventors: Fnu Resnofendri, San Jose, CA (US); Haochen Yu, Toronto (CA)

(21) Appl. No.: 15/706,480

(22) Filed: Sep. 15, 2017

Related U.S. Application Data
(60) Provisional application No. 62/483,770, filed on Apr. 10, 2017.

(51) Int. Cl. G06F 17/30

(52) U.S. Cl. CPC G06F 17/30005; G06F 17/30345; G06F 17/30342; G06F 17/30867

(57) ABSTRACT

The present application is directed towards a database that includes discoverable information regarding various products available. Each entry within the catalog includes any related discoverable information associated with products that fall in categories such as software, hardware, computing devices, and cloud-based services. Furthermore the catalog can be updated automatically to ensure that the information stored within the catalog is up-to-date and responsive to the needs of the customer.

### CROSS-REFERENCE TO RELATED APPLICATIONS

The present application claims the priority benefit of U.S. provisional application No. 62/483,770 filed Apr. 10, 2017 and entitled “Curating Objects”, the disclosure of which is incorporated herein by reference.

### BACKGROUND

### Field of Invention

The present invention generally relates to curating objects. More specifically, the present invention relates to curating objects for a standardized database.

### Description of the Related Art

There are many different types of software and hardware available to the public. Each type of software and hardware available may have a lot of different types of information associated with it. For example, some information may pertain to requirements and performance related to running the software or hardware on different computing devices. Customers may need this information in order to figure out whether their own personal computing device is compatible with the software or hardware. Other types of information related to each type of software and hardware may change over time. Such information can include any issues or updates that address issues (e.g. bugs) with the software and hardware.

In many situations, information about software and hardware would be typically be packaged with the software and hardware. For example, the software and hardware may be packaged and sold in a box. Sheets of paper or a booklet may be included within the box that includes various types of information that the customer could read regarding the software and hardware. This information may be curated to include a subset of information that most people would find helpful. However, this information may not be complete (e.g. may not include specific information that the customer is interested in). Furthermore, since the information is printed, this information may not be up-to-date.

Information about software and hardware can also be found on the Internet. For example, manufacturers of each software and hardware may have many different webpages that contain more information than that could be included in the box that may be useful for the customer to learn more about the software or hardware. The information may be organized on different portions of the webpages, for example, based on the type of information. With the internet, the information can be updated on a regular basis so that the customer can obtain up-to-date information as new updates and modifications are available to the public.

However, for a customer to figure out information about corresponding software or hardware via the webpages, the customer would need to first search for and find the related information. The relevant information may be stored in many different locations on the webpages and may not be easily accessible or found. Furthermore, there is no easy way to compare information from different sources (e.g. manufacturer vs. third party). There are also challenges with ensuring that the information being viewed is up-to-date. Information on the web-pages may not be immediately updated or there is no indication when the information was last updated. In order to achieve any of the above, the customer would need to spend time and resources to obtain the information and perform the comparison by looking for the information on the various pages, menus, tables, etc. . . . This takes time and resources and does not guarantee that the customer obtains the correct information.

There is a need to have a database that obtains, curates, and stores information about each software and hardware so that it is organized and easily accessible by the customer. Furthermore, this database would actively update the information stored within the database so that customers are provided accurate and up-to-date data based on any information that is currently available from a variety of different sources.

### SUMMARY OF THE CLAIMED INVENTION

A method for automatically curating objects into a database is presently claimed. The method includes receiving a user request for information associated with a database. The method then identifies a portion of the requested information that may not be available in the database. In which case, the method proceeds to retrieve the unavailable information from one or more other sources. The retrieved information is then processed so that it can be properly verified and formatted to be consistent with the database. After processing, the database is updated with the information thereby making available the previously unavailable information.

A non-transitory computer-readable storage medium that includes a program that is used to perform a method for automatically curating objects into a database is presently claimed. The program would first receive a user request for information associated with a database. The program then identifies a portion of the requested information that may not be available in the database. In which case, the program proceeds to retrieve the unavailable information from one or more other sources. The retrieved information is then processed so that it can be properly verified and formatted to be consistent with the database. After processing, the database is updated with the information thereby making available the previously unavailable information.

A system for automatically curating objects into a database is presently claimed. The system includes a database that is used to store information regarding various products. A client device is also provided that is associated with a user. Lastly, a server is associated with the database. The server receives user request for information from the client device. The server then identifies a portion of the requested information that may not be available in the database. In which case, the server proceeds to retrieve the unavailable information from one or more other sources. The retrieved information is then processed so that it can be properly verified and formatted to be consistent with the database. After processing, the database is updated with the information thereby making available the previously unavailable information.

### BRIEF DESCRIPTION OF THE DRAWINGS

FIG. 1 is a flow chart illustrating a method used to incorporate or update information within the database based on input from a customer.

FIG. 2 is a flow chart illustrating a gapfill process used to incorporate or update information within the database based on a query from a customer.

FIG. 3 illustrate different automated methods for incorporating or updating information within the database

FIG. 4 illustrates an example format for the database that includes various different types of information stored with each product.

FIG. 5A and FIG. 5B illustrate implementation of the crawlers of FIG. 3.

FIG. 6 is a flowchart illustrating a method for the gapfill process of FIG. 2.

FIG. 7 is a flow chart illustrating a method for cataloging discoverable information.

FIG. 8 illustrates a block diagram of an example user (i.e. client) device.

### DETAILED DESCRIPTION

The present application is directed towards a database that is used to store discoverable information regarding different objects in a standardized format. Each entry within the database includes related discoverable information associated with the object. Example objects include software, hardware, computing devices, and cloud-based services.

In many cases, the discoverable information stored within the database pertains to information that users (e.g. customer) would like to know about a given object. For example, an object may be a particular piece of software. The information stored within the database would include related information about the software such as information about the manufacturer, publisher, product name, version/edition/addition, release date, any attributes associated with the product (such as specifications/requirements for operation), pricing, licensing terms, end of life, and any security risks.

The format used to store the information within the database is standardized. For example, a manufacturer associated with various products within the database would be identified the same way each time. Furthermore, discoverable information associated with a particular characteristic of a product in the database may also be formatted or mapped in order to display information in a similar manner. The standardization of the information provided in the database provides benefits such as allowing the comparison between different objects to occur more easily. Furthermore, the standard format allows the information within the database to be compatible with different applications. In this way, different applications can be used to access the same information stored within the database. This facilitates user access and viewing of the information stored within the database.

Since the database includes related information about a variety of different objects, the customer (e.g. user) can access and use the database to address any queries they may have regarding an object of interest. For example, if the customer would like to know if their computing device is capable of running a given piece of software, a search of the database would retrieve information associated with the computing device of the customer and requirements for running the software. This information can then be provided to the customer so that a determination can be made based on the original request of the customer regarding whether the software is compatible and/or the computing device has the resources to run the software.

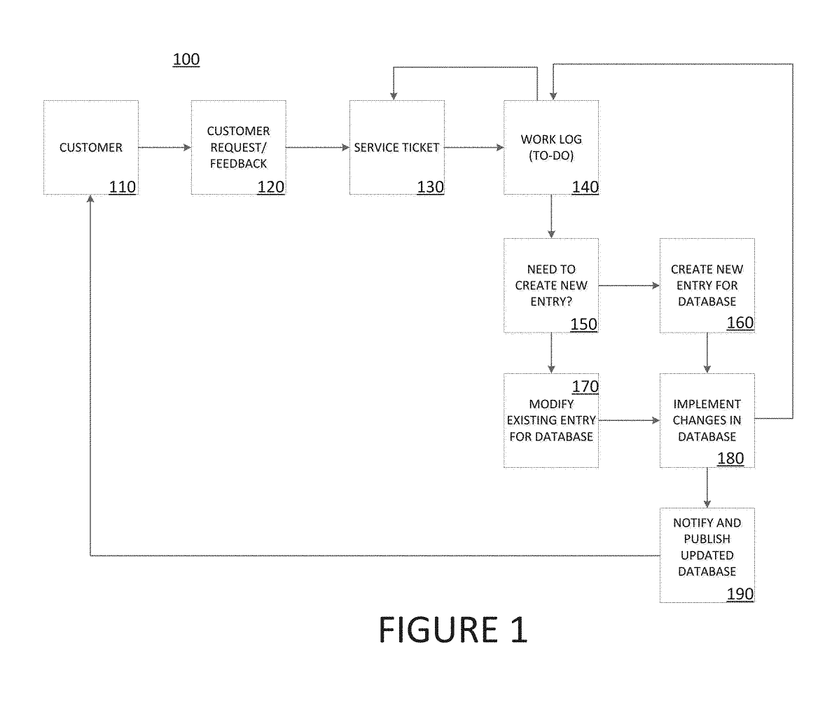

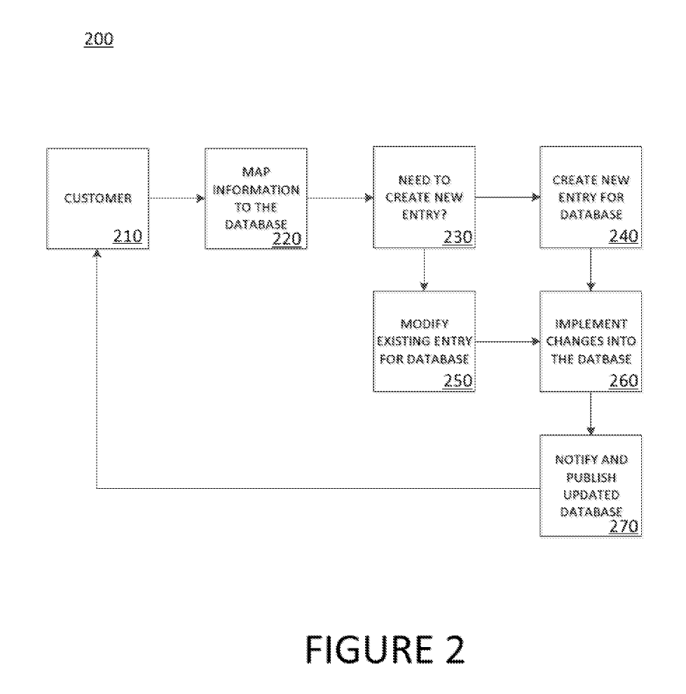

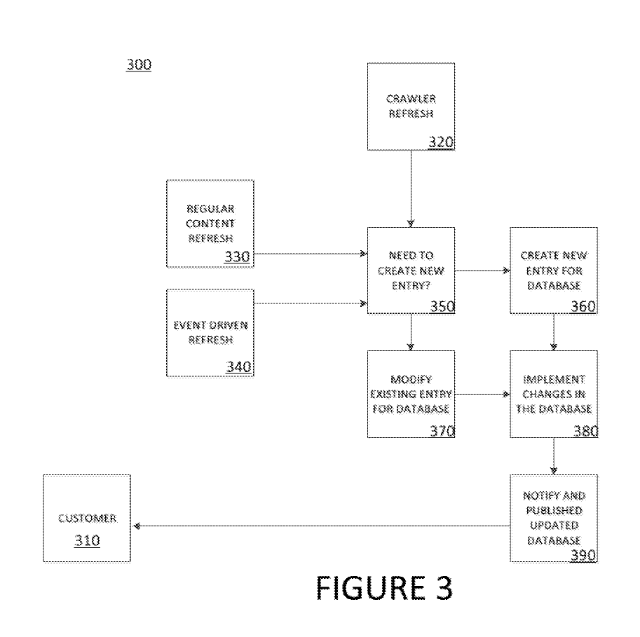

FIGS. 1-3 are flowcharts illustrating different methods of incorporating and updating information in a standardized database. In particular, FIG. 1 is a flow chart illustrating a method used to incorporate or update information within the database based on input from a customer. FIG. 2 is a flow chart illustrating a gapfill process used to incorporate or update information within the database based on a query from a customer. FIG. 3 illustrate different automated methods for incorporating or updating information within the database.

With reference to FIG. 1, the flowchart 100 corresponds to situations where a customer 110 may provide a request for or provide feedback about 120 information that is not currently stored within the database. The request/feedback 120 can also be provided by the customer 110 to inform about out-of-date or incomplete information. The flowchart 100 illustrates the steps performed for the creation of the missing information for the database as well as updating the database if information included within is out-of-date or incomplete.

In step 120, the customer 110 provides a request or feedback about the information stored within the database. In an example situation, the customer 110 may provide a request regarding information about a product (e.g. software, hardware, computing device, cloud-based service) that presumably is stored in the database. If the requested information is available, the requested information would be provided directly to the customer 110. In some embodiments, a portion of the database such as a packaged data set can be provided to the customer 110 responsive to the request for information.

However, if the customer's request is directed towards information that is not currently stored in the database, this would trigger a need to search for this requested information. This trigger may be automatically generated on behalf of the customer 110 to search for the requested information 120. In some situations, the customer may also receive information from the database but may later find out that the information is incomplete or out-of-date. In this case, the customer 110 may also provide feedback 120 indicating that the information that was retrieved from the database was incomplete or out of date

In response to the customer request or feedback provided in step 120, a service ticket may be generated in step 130. The service ticket is used to identify that an issue with the database has been raised. The issue can be listed regarding whether new information needs to be added to the database that previously didn't exist or if an existing entry needs to be modified or updated. The service ticket may also include information about the customer 110 that provided the request/feedback in step 120. The customer information is useful so that once the database has been updated based on the customer request/feedback 120, the updated information can also be provided to the customer 110.

In step 140, the request/feedback from the customer 110 is logged into a work log. The work log 140 is used to manage the modifications that need to be performed on the database. Based on the request/feedback from the customer 110, the work log 140 assigns the request for information to be completed. The requested information may be performed automatically by an application. In some situations the requested information can also be searched for by an administrator responsible for managing the database.

The requested information that is currently missing from the database may be searched in any number of different ways. For example, there may be pre-determined locations associated with each product (e.g. manufacturer's website) where the missing information can be searched for. The information that is retrieved in step 140 can be temporarily stored in a content database for later use.

For situations where the request/feedback from the customer 110 is not understood, the work log 140 may re-process the service ticket from step 130 or request further clarification from the customer 110 directly.

In step 150, the request/feedback 120 obtained from the customer 110 is evaluated with the information obtained in step 140 in order to determine if 1) a new entry should be created within the database to store the requested information, or 2) an existing entry could be associated with the requested information but for some reason does not include the requested information. This evaluation may search through the existing entries within the database to determine if the requested information can be mapped to an existing entry. For example, perhaps the customer 110 is requesting information about a product where the information may be stored with a variety of different terms.

In step 160, a determination that a new entry would need to be added to the database is reached based on the evaluation performed in step 150. This may correspond to a new product release that has not yet been included in the database.

In step 170, a determination that an existing entry could be modified is reached based on the evaluation performed in step 150. This may correspond to a new version of a product release. The information associated with the underlying product may already exist in an existing entry. This step would allow the entry to be updated with information regarding the new version.

In either case (step 160, 170), once a determination has been reached regarding whether a new entry should be created or an existing entry should be modified, the information that was retrieved in step 140 is incorporated into the database in step 180. The information can be provided from the content database associated with the work log.

Furthermore, a check of the work log 140 will be performed in order to determine if there are any more updates needed to be performed on the database in step 180. If no further updates are needed, the various customers 110 can be informed that the database has been updated.

Notifications to the various customers 110 can be provided to inform that the database has been updated in step 190. Updates to the database may also be pushed out to the customer 110 in step 190. These updates to the database can be provided to the customer 110 automatically. The updates to the database may also be pushed out to the customer 110 at pre-determined periods of time (e.g. at scheduled maintenance periods).

The way the updates are provided to the customer 110 can also depend on the amount of information in the database being updated. The updates may be provided via individual packages of information specific to the updates performed on the database. This may be preferred if a few unrelated entries within the database are updated during a period of time. However, in situations where sections of a database have been updated, the updates can push out entire portions of the database that were affected by the update at one time to the customer 110.

With reference to FIG. 2, the flowchart 200 corresponds to a situation where the customer 210 provides information that would be incorporated into the database. Steps 230-270 of FIG. 2 are similar to step 150-190 of FIG. 1. The main difference arises with the source of the information being incorporated into the database. With respect to FIG. 1, new information was retrieved and incorporated into the database in response to a request or feedback from the customer. With reference to FIG. 2, information from the customer 210 is provided to be incorporated into the database.

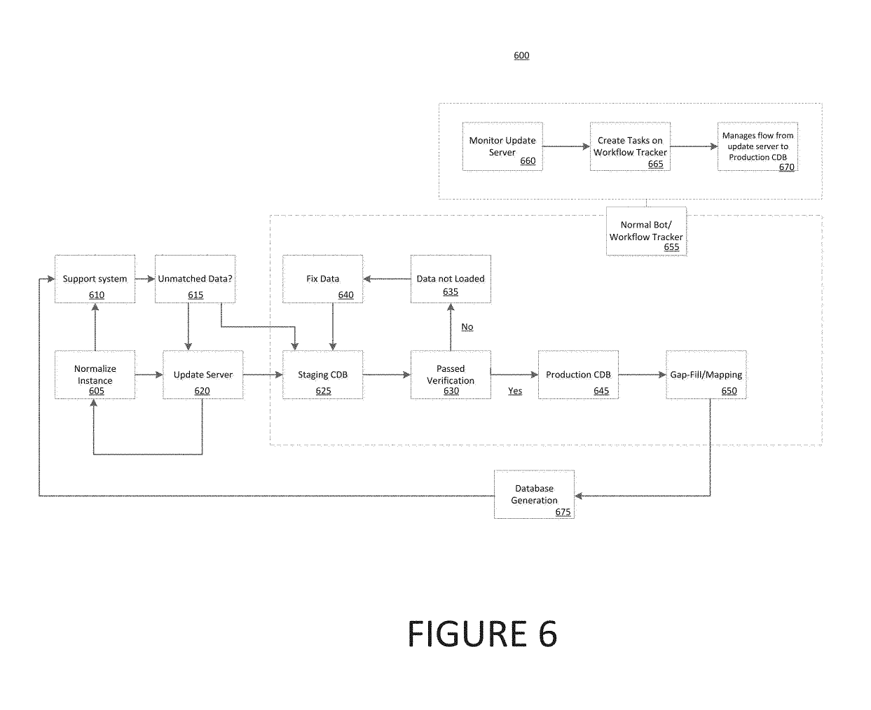

In step 220, the information provided by the customer 210 would need to be mapped to the database. Since the database is aimed at being compatible with various different customers, there was a need to synchronize different naming conventions for products, features, and information so that the same product, feature, or information described differently by different customers would all be understood as meaning the same thing. Additional details regarding the gapfill process will be provided below in FIG. 6.

With reference to FIG. 3, the flow chart 300 identifies additional conditions where information can be incorporated into the database. Instead of the customer 310 influencing when the database becomes updated as described above in FIG. 1 and FIG. 2, the database is instead updated based on various conditions associated with the database. Similar to the flowchart of FIG. 2 with reference to steps 230-270, the steps 350-390 of FIG. 3 are similar to steps 150-190 of FIG. 1. The difference arises on the different conditions where the database may be automatically updated.

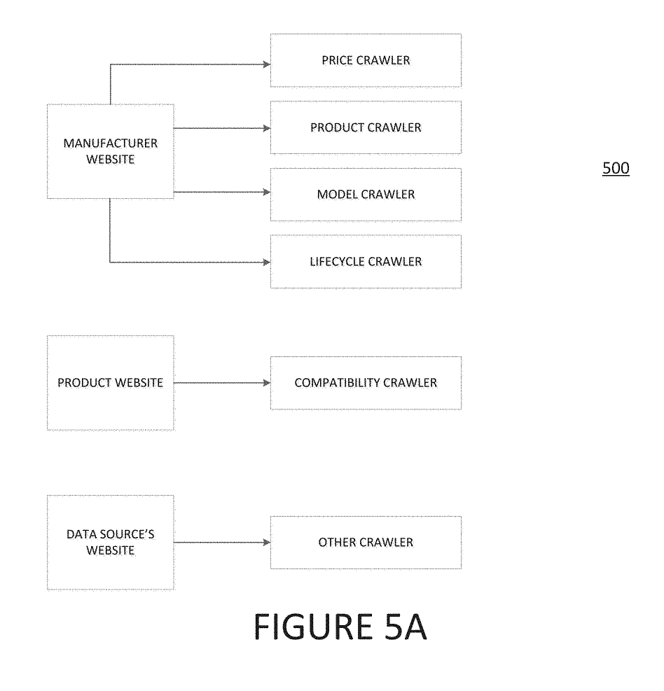

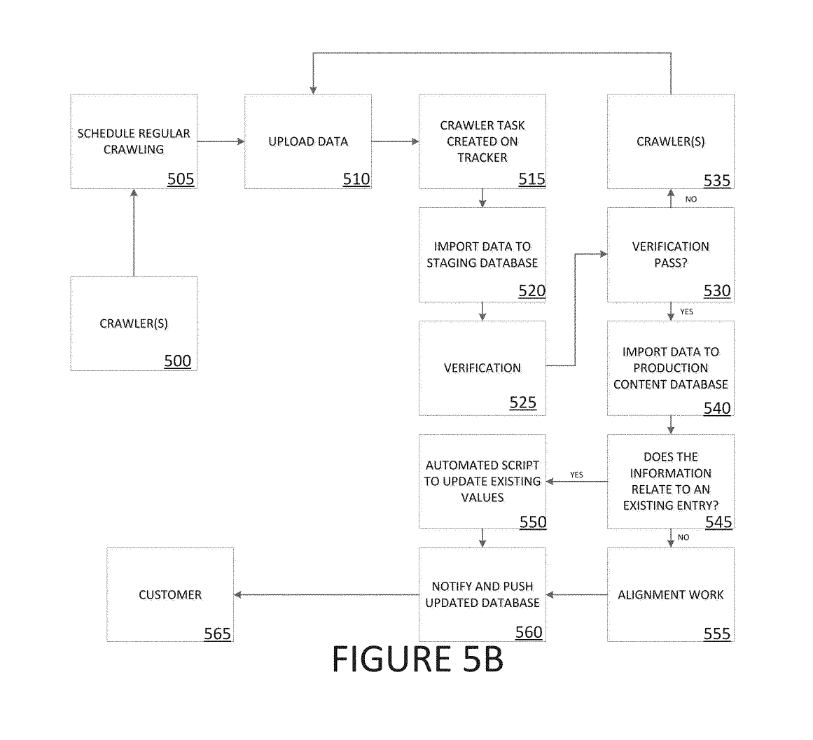

With respect to the crawler refresh 320, regular content refresh 330, and event driven refresh 340, information for the database is retrieved at certain periods of time. In the case of crawler refresh 320, a crawler is used to collect any related information that ca be used to update the database. The crawler is an automated script that is designed to search for and retrieve a specific type of information. Further details regarding the crawler refresh process 320 is described in FIG. 5A and FIG. 5B. The regular content refresh 330 and the event driven refresh 340 would correspond to conditions for searching for and updating the database. For example, the regular content refresh 330 may correspond to a schedule (e.g. weekly basis) for updating the database. In contrast, the event driven refresh 340 would monitor for specific events (e.g. notification regarding a new product release) that could be used to trigger the search for new/updated information. The notification could at least infer that new information would be available to be incorporated into the database

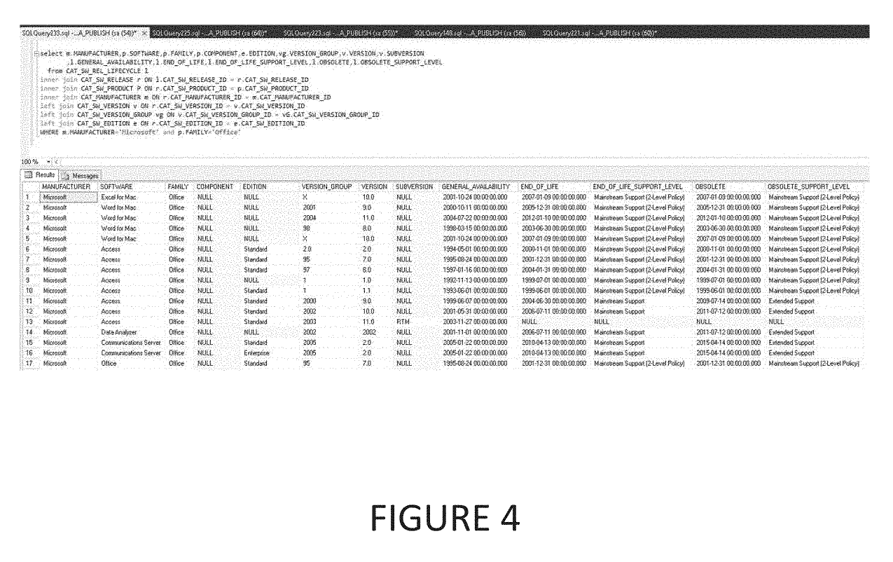

Each of the entries within the database may be organized any number of different ways. For example, the database may include characterization and organization of information that distinguishes between different types of products (e.g. software, hardware, computing devices, cloud-based services). Further characterization and organization can also be used to distinguish between types of a given product (e.g. types of software). As illustrated in FIG. 4, an example database is provided that shows how different products may be organized. At least in this figure, the different products are organized by manufacturer and product name. For each type of information (or characteristic) retrieved about a product, a column can be provided that would include a value or information associated to that characteristic.

In a further embodiment, information for the database can also be provided by an individual, manufacturer or third party via an application programming interface (not shown). In order to ensure that the information that is provided can be verified, an administrator may be the only entity authorized to make any additions or modifications directly to the database. The administrator can evaluate the validity of the information before it is entered into the database. Furthermore, the administrator can control (e.g. standardize) the information being entered into the database and ensure that no duplicate entries are created in view of the information being provided. Alternatively, the information provided via the application programming interface can be forwarded to the processor for post processing.

FIG. 5A and FIG. 5B illustrate implementation of the crawlers of FIG. 3. In particular, FIG. 5A illustrate various different crawlers 500 used to obtain specific information from different sources while FIG. 5B illustrates how the different crawlers 500 and information obtained via the crawlers 500 would be used to update the database.

With reference to FIG. 5A, there may be different crawlers 500. Each crawler 500 may be specific for a particular piece of information (e.g. price, product, model, lifecycle, compatibility). Each crawler 500 can also be specific regarding the source the information is being obtained from (e.g. manufacturer website, product website).

Information about different products can be retrieved from many different sources. For example, there are many different websites that exist. These websites may include information specific to a particular product stored within the database. In this case, information retrieval can be implemented through the use of crawlers 500 or scripts run on an application that are programmed to look for, retrieve, and enter/update particular types of information associated with the product into the database.

As mentioned above, the crawlers 500 are programmed via their scripts to identify where the related information is stored. In some embodiments, these crawlers 500 may be specifically programed to operate with respect to a particular manufacturer website. Furthermore, these crawlers 500 may be specifically programmed to operate with respect to a particular product website. These crawlers 500 can also be programmed to operate with respect to a particular piece of data to retrieve. The script provides the crawler 500 an understanding of what types of information is stored on the related website, where the information is stored, what information should be retrieved for the database, and what should be done with the information after it has been retrieved. In this way, each script may need to be customized to correspond with information associated with a particular manufacturer, website, product or data being retrieved. Furthermore as websites become updated, the scripts for each related crawler 500 may also need to be updated accordingly.

For example, an example crawler may be instructed to find and update the “end-of-life” information for a particular product. The crawler would be customized (via the script) to go to a particular portion of a website and retrieve the related information regarding the requested end-of-life information.

FIG. 5B further expands on the implementation of the crawlers of FIG. 3. In particular, FIG. 5B illustrates what is done with the information that is obtained via the crawlers of FIG. 5A.

In step 505, crawlers may be scheduled to search for information to update or add to the database. Each of the crawlers 500 may be instructed to search for (e.g. crawl) for information based on various conditions. In some situations, the crawler 500 may search for information at pre-determined periods of time (e.g. daily, weekly), based on an update notification, or in response to a request for updated information. In some cases, the frequency in which a crawler is used to obtain information to update the database may be based on the type of information being retrieved. For example, information regarding version or operational requirements for a product (e.g. software, hardware) may be updated on a less frequent basis compared to information regarding potential security issues or bugs.

Once the crawler 500 finds and retrieves the corresponding information, the information obtained can be stored temporarily in a database until it can be processed (step 510). The storage of the information is necessary in order to allow for the verification of the information that was retrieved by the crawler 500. In other words, the information from the crawler 500 would need to be checked to determine if the corrected information was retrieved. If, for example, the wrong information was retrieved by the crawler 500, this may be indicative that the information has been moved or the crawler 500 was not properly instructed. In either case, there may need to be updates to the instructions (e.g. script) used by the crawler to look for the requested information.

Once crawler 500 retrieves the information and the information is stored (in step 510), a list of tasks (e.g. crawler task tracker) is updated in step 515. The list of tasks 515 tracks various different information retrieved from different crawlers 50 that still need to be processed. The list of task 515 can be used to allocate an order (e.g. queue) or importance of completing the processing of the information obtained by the crawlers (e.g. performs verification of the data as well as evaluate whether the data would be incorporated into the database).

In step 520, the information that was initially stored in step 510 can be transferred to a staging database. The staging database corresponds to a workspace where the information obtained from the crawler 500 will be verified (in step 525). Validity corresponds to whether the information obtained from the crawler is correct. Different checks can be performed on the information in order to make the determination as to whether the information is correct. For example, the information may be reviewed to see if it is understandable, if the information is in an expected format, or if the information is expected.

Based on the verification performed in step 525, a determination in step 530 is reached regarding whether the information can be used. If it is determined that the information was wrong (e.g. the wrong information was retrieved, missing information), the crawlers may be instructed to retrieve the information again (in step 535). The information can then be re-evaluated to determine if perhaps an error occurred during the upload (step 510) and importing of the data into the staging database (in step 520). If the error persists, this may require a re-evaluation of the crawler 500 used to see if the error can be addressed via updates to the crawler 500 itself.

If the determination is that the information is found to be appropriate or valid, then the information obtained from the crawler 500 can be then provided to a content database (in step 540) where a further evaluation is performed regarding what should be done with the information. In particular, in step 545 a determination is made regarding whether the information retrieved via the crawlers 500 should be used to update an existing entry within the database (in step 550) or if the information retrieved is new information and would need to be aligned with the database (in step 555).

In situations where information about a product needs only to update a value (e.g. end of life date, price, issues), step 550 allows for the updating of entries within the database with the information obtained from the crawler 550. Since the entry already exists within the database, there is no need to generate a new entry within the database. The updated information would need to be formatted so that it is compatible with the entry within the database.

In situations where the information about a product is completely new (e.g. version) or the information corresponds to a new product altogether, the information obtained from the crawler would need to be aligned (in step 555) so that the information can be consistently stored within the database. The alignment may involve mapping terminology and naming conventions used to store information within the database. Formatting of the data so that the information is consistent may also be done.

After each update has been performed or after all updates have been performed, notifications regarding the updates can be provided to the customer 565 in step 560. Furthermore, the actual updates to the database can also be provided to the customer 565.

As described above, customers 565 can be notified that updated information have been incorporated (or published) with the database. This means that the new information is now accessible by customers querying the database. Furthermore, update services may provide the new or updated information in the database to customers who have previously downloaded packaged data from the database. The update services may include the information that relates to the new or updated portions of the database. The updated information can be provided directly to the customer so that their portion of the database can include the new or updated information as well without needing to re-download the entire data package again.

FIG. 6 is a flowchart illustrating a method 600 for the gapfill process of FIG. 2. The gapfill process 600 is used for situations where new information for products may be added in the database where an entry may not previously exist in the database. The gapfill process 600 may be triggered from a customer request/feedback for information. The gapfill process 600 may also be triggered from a crawler that obtains new information.

In step 605, a customer may be running an application that is used to request information about a product that is currently stored on their computing device. The application (i.e. Normalize) characterizes the product using a variety of different attributes. These attributes will be used in matching the product on the customer's computing device with an entry associated with the product stored on the database.

In step 610, a support system evaluates the information from the application in order to attempt to match the product with an entry within the database. If a direct match occurs, the corresponding information is deemed to exist in the database and the customer can be provided the information about the product. In situations where there are similarities between the attributes of the application being characterized by the application with an existing entry (compared to a pre-determined threshold), the database may still provide the information about the similar product. For example, if one or two attributes are off, this may signify that the two products may still be similar enough that the information for the similar product would still be relevant for the actual product that is on the customer's client device. However, there may also need to be updates performed on the database (e.g. via crawlers) before any sort of information is provided to the customer if the difference exceeds a first pre-determined threshold). For example, similar (but not exact matches) attributes may correspond to different versions of the same product. The different version may not yet have information stored in the database. In this case, the updated information will be retrieved and uploaded into the database before being provided to the user.

However, in situations where no direct match occurs (e.g. the difference exceeds a second pre-determined threshold that is greater than the first pre-determined threshold), this may signify to the method 600 that a new entry may need to be generated for the database. The database will need to be updated with the missing information before anything can be provided to the customer about the product that is currently stored on the customer's computing device.

In step 615, detection that a possible new product that is not stored in the database is reached. The information about the new product is then forwarded to the update server in step 620. The update server accumulates that data from the customer computing device associated with the possible new application that will then be processed for use in updating the database.

The information stored within the update server (in step 620) is then pushed to the staging content database (CDB) in step 625. Similar to the staging database described above in FIG. 5, the staging database in step 625 is a workspace where information from the update server will be verified in step 630. Although the information within the staging CDB is provided in some instances from the update server in step 620, it may also be possible that the information (e.g. attributes associated with a product on the customer's computing device) can also be provided manually (e.g. after step 615) after the determination that a new entry may be needed in the database.

The normal bot/workflow tracker 655 is used to manage the flow of information stored in the update server (in step 620) into the staging (step 625) and product content databases (step 645). The normal bot/workflow tracker 655 monitors the information that is being stored within the update server in step 660. As the information is stored, tasks are created in the workflow tracker in step 665 that inform what information still need to be processed. The workflow tracker (in step 665) may assign an order or priority for completing the process of the information. This information can then be assigned an order for completion based on, for example, when the information was initially stored within the update server or priority.

In step 670, the normal bot/worker flow tracker can manage the actual flow of information from the update server into the staging CDB in step 625. For example, the flow of information from the update server (in step 620) can be based on the available resources for verifying (in step 630) and/or updating the database (in step 650). There may be situations that the flow tracker (in step 670) would control the flow of information that would need to be processed by the gapfill process 600 so that the resources used for the gapfill process 600 are not over loaded.

The normal bot/workflow tracker (in step 655) may also track where the information that is stored within the update server (in step 620) originates from. In this way, once the database has been updated, the corresponding customer can be provided the updated information.

In step 630, verification of the data from the update server (in step 620) is performed. Verification is performed to ensure that the data, for example, is understandable or in a proper format. If the verification in step 630 fails, the information from the update server 620 will not be forwarded to the production content database in step 645 to be incorporated into the database. Rather, the failed information will be designated as not to be loaded in step 635. After being designated to not be loaded, the gapfill process 600 can then attempt to obtain the correct information in step 640. This may involve reformatting the information so that it is within the correct format or converted into a manner that is understood by the gapfill process 600. In some situations, the fix data step (in step 640) may request the customer computing device for the information again (not shown) or may attempt to retrieve the same information from the update server (in step 620) again. The fix data step (in step 620) may do so in order to figure out if the issue/problem arose from some error in the transfer or storage of data.

If the information, however, was verified as being appropriate (e.g. understood, proper format), the new information can then be provided to the production content database in step 645. In this step, a further determination is performed on the data to determine what should be done. In some cases, the information may correspond to an existing entry and the gapfill process 600 will just need to update the new information to the existing entry in step 650. However, if the information that is in the production CDB (in step 645) is new thereby requiring a new entry to be added to the database, the gapfill process 600 in step 650 will then generate a new entry and map the information into the format that is consistent with the data base. Once completed, the database will now contain the previously unaccounted for information for the product in the database corresponding to the product on the customer's computer.

Once the entry has been generated in step 650, the rest of the information is searched for and inputted into the newly generated entry in the database in step 675. This may involve, for example, generating and using crawlers to obtain related information about the new entry to be stored within the database.

Once the database has been updated, the new entry from the database can be provided to the customer. To determine who should receive the new entry, the support system in step 610 can be queries to identify the customer's computing device that initially provided the information associated with the new entry. It should be noted that in some situations, updated portions of the database and/or the entire updated database can also be provided to the customer as well. The updated information associated with the database can be provided upon availability once it has been incorporated into the database but can also be provided at pre-determined periods of time (e.g. next maintenance or update period).

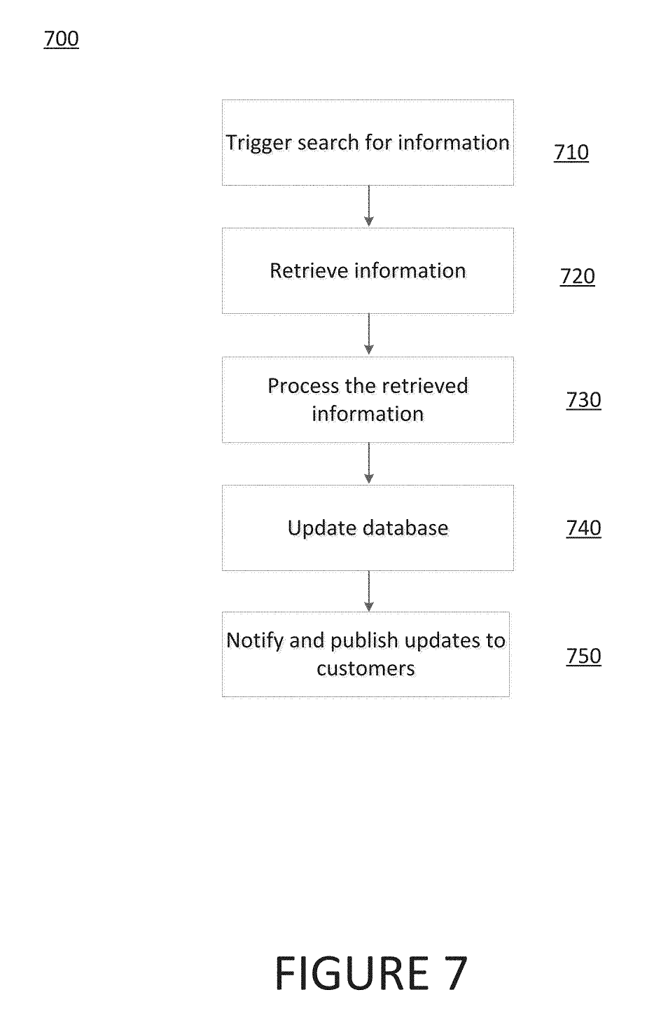

FIG. 7 illustrates an exemplary method 700 for cataloging discoverable information. In step 710, the database may receive a notification that a search for information may be needed. For example, this notification may be related to a query from a customer, gapfill process (for new information not currently found in the database), automated crawler instructions or refresh conditions.

In step 720, information related to a particular product may be retrieved from one or more sources. The information may be retrieved, for example, from a website through the use of crawlers. Information may also be provided from other sources, for example, from the manufacturer of a product via an application program interface. These information would be usable with the database (either adding new information not previously found in the database or updating existing information stored in the database).

In step 730, the retrieved information undergoes post processing. The post processing associated with the retrieved information includes verifying the accuracy of the information and formatting the information so that the data is consistent with the format of the database. Furthermore, an evaluation of whether the information is new or used to update an existing entry is also performed. After the processing of the retrieved data, the database can be updated accordingly (in step 740).

In situations where customers are provided portions of the content via data packages, update services can provide the updated information used with the database to the affected customers (in step 750). This allows the customers to have access to the updated information without having to re-download or request the data package again.

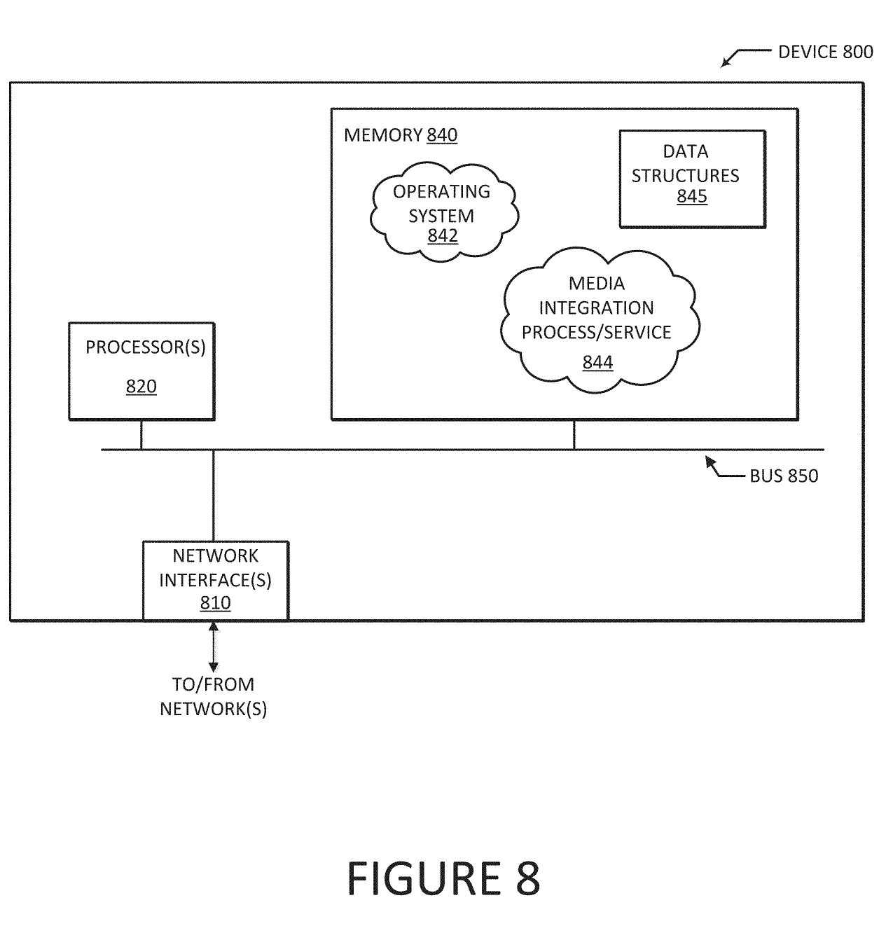

FIG. 8 illustrates a block diagram of an example user (i.e. client) device 800. The exemplary user device 800 (e.g., desktop, laptop, tablet, mobile device, console gaming system) is a device that the user can utilize in connection with carrying out features of the present invention. As shown, device 800 includes one or more network interfaces 810 (e.g., transceivers, antennae, etc.), at least one processor 820, and a memory 840 interconnected by a system bus 850.

Network interface(s) 810 contain the mechanical, electrical, and signaling circuitry for communicating data over links coupled to one or more networks. Network interfaces 810 are configured to transmit and/or receive data using a variety of different communication protocols, as will be understood by those skilled in the art. For example, the network interface(s) 810 can be used to communicate between the customer's user device and the database that stores information about the various products that may be stored on the customer's user device.

Memory 840 comprises a plurality of storage locations that are addressable by processor 820 for storing software programs and data structures associated with the embodiments described herein. For example, memory 840 can include a tangible (non-transitory) computer-readable medium, as is appreciated by those skilled in the art.

Processor 820 may comprise necessary components, elements, or logic adapted to execute the software programs and manipulate data structures 845, which are stored in memory 840. An operating system 842, portions of which are typically resident in memory 840, and is executed by processor 820 to functionally organize the device by invoking operations in support of software processes and/or services executing on the device. These software processes and/or services may comprise an illustrative “media integration” process/service 844. Note that while process/service 844 is shown in centralized memory 840, the process/service may be configured to operate in a distributed communication network. An example process/service that may be run on the user device may include an application that extract and characterize attributes associated with products stored on the user device. The application can 1) provide an initial characterization of information from the computing device that can be used to identify the products stored on the computing device and 2) identify the relevant information about the products that the customer may want to view.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes. For example, processor 820 can include one or more programmable processors, e.g., microprocessors or microcontrollers, or fixed-logic processors. In the case of a programmable processor, any associated memory, e.g., memory 840, may be any type of tangible processor readable memory, e.g., random access, read-only, etc., that is encoded with or stores instructions that can implement program modules, e.g., a module having spectator channel process 844 encoded thereon. Processor 820 can also include a fixed-logic processing device, such as an application specific integrated circuit (ASIC) or a digital signal processor that is configured with firmware comprised of instructions or logic that can cause the processor to perform the functions described herein. Thus, program modules may be encoded in one or more tangible computer readable storage media for execution, such as with fixed logic or programmable logic, e.g., software/computer instructions executed by a processor, and any processor may be a programmable processor, programmable digital logic, e.g., field programmable gate array, or an ASIC that comprises fixed digital logic, or a combination thereof. In general, any process logic may be embodied in a processor or computer readable medium that is encoded with instructions for execution by the processor that, when executed by the processor, are operable to cause the processor to perform the functions described herein.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed:

1. A method for automatically curating objects in a database, the method comprising:
receiving a user request for information associated with a database;
identifying that a portion of the requested information is not available in the database;
retrieving the unavailable information from one or more other sources;
processing the retrieved information, wherein the processing includes:
verifying the retrieved information, and
formatting the retrieved information to be consistent with a format associated with the database; and
updating the database with the processed information.

2. The method of claim 1, further comprising transmitting the processed information used to update the database to one or more users, wherein the one or more users have data packages that include a portion of the database that corresponds to the processed information.

3. The method of claim 1, wherein retrieving the unavailable information from one or more other sources is performed through customized crawlers, wherein the customized crawlers include instructions to search for the unavailable information from the one or more other sources.

4. The method of claim 3, wherein a customized crawler is created for each source being searched.

5. The method of claim 3, wherein a customized crawler is created for each type of information being searched.

6. The method of claim 1, wherein the one or more other sources includes a website associated with the unavailable information.

7. The method of claim 1, wherein the unavailable information is information about a new version of a product.

8. A non-transitory computer-readable storage medium having embodied thereon a program, the program being executable by a processor to perform a method for automatically curating objects in a database, the method comprising:
receiving a user request for information associated with a database;
identifying that a portion of the requested information is not available in the database;
retrieving the unavailable information from one or more other sources;
processing the retrieved information, wherein the processing includes:
verifying the retrieved information, and
formatting the retrieved information to be consistent with a format associated with the database; and
updating the database with the processed information.

9. The non-transitory computer-readable storage medium of claim 8, further comprising transmitting the processed information used to update the database to one or more users, wherein the one or more users have data packages that include a portion of the database that corresponds to the processed information.

10. The non-transitory computer-readable storage medium of claim 8, wherein retrieving the unavailable information from one or more other sources is performed through customized crawlers, wherein the customized crawlers include instructions to search for the unavailable information from the one or more other sources.

11. The non-transitory computer-readable storage medium of claim 10, wherein a customized crawler is created for each source being searched.

12. The non-transitory computer-readable storage medium of claim 10, wherein a customized crawler is created for each type of information being searched.

13. The non-transitory computer-readable storage medium of claim 8, wherein the one or more other sources includes a website associated with the unavailable information.

14. The non-transitory computer-readable storage medium of claim 8, wherein the unavailable information is information about a new version of a product.

15. A system for automatically curating objects in a database, the system comprising:
a database that stores information associated with a database;
a client device associated with a user; and
a server associated with the database, wherein the server
receives a user request for information associated with the database,
identifies that a portion of the requested information is not available in the database,
retrieves the unavailable information from one or more other sources,
processes the retrieved information, wherein the processing includes:
verifying the retrieved information, and
formatting the retrieved information to be consistent with a format associated with the database, and
updates the database with the processed information.
